(19) United States
(12) Patent Application Publication
(10) Pub. No.: US 2008/0036382 A1
(43) Pub. Date: Feb. 14, 2008

(54) Light Source And Method For Mechanically Stabilizing The Filament Or Electrode Of A Light Source

(76) Inventors: Gerhard K. Wolf, Heidelberg (DE); Frank Friess, Otterstadt (DE); Georg Schwarz, Dossenheim (DE); Adalbert Kovacs, Dossenheim (DE); Axel Bunk, Munchen (DE); Georg Rosenbauer, Wassertrudingen (DE); Matthias Damm, Gaimersheim (DE)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/572,300

(22) PCT Filed: Jul. 11, 2005
(86) PCT No.: PCT/DE05/01216

§ 371 Date: May 17, 2007

(30) Foreign Application Priority Data
Jul. 19, 2004 (DE) 10 2004 034 807.3

(51) Int. Cl. H01J 17/04; H01J 9/00

(52) U.S. Cl. 313/631; 445/58

(57) ABSTRACT

A light source comprising a heatable filament (1) or an electrode, wherein the filament (1) or the electrode is arranged in a lamp (2) or in a tube. In order to use the light source in a wide variety of manners even in rough conditions, the filament (1) or the electrode is provided at least partially with a mechanical stabilization system. The invention also relates to a method for mechanical stabilization of the filament (1) or electrode of a light source, wherein stabilization is produced by exposing the filament (1) or electrode to a short pulsed gas pressure increase, involving a rare gas, during heating. Stabilization may also be produced by a coating or deposition (4).

The present invention relates to a light source having a heatable filament or electrode, the filament or electrode being situated in a bulb or tube. The present invention further relates to a method for mechanically stabilizing the filament or electrode of a light source.

Light sources of the aforementioned type have been known in practice for quite some time, and exist in various embodiments. Electrical filament lamps, electrical halogen lamps, and electrical discharge lamps in low- or high-pressure applications as well as electrical light-emitting diodes are known in particular. The light sources are based on thermionic emissions, impact excitation of gases, or a luminescent effect, for example in luminescent tubes.

Furthermore, for various application fields it is now common to manufacture specialized, individual types of light sources that are especially suited for the particular application. For example, in isolated cases specialized filaments such as tantalum carbide filaments have been used in light sources requiring a high light output.

For many specialized filament or electrode materials it is disadvantageous that, although these materials meet the desired requirements for light output, they are frequently sensitive to shock and vibrations, which often results in breakage of the filaments or electrodes. Such filaments or electrodes are therefore not suitable for uses requiring special attention. The light sources equipped with the known filaments or electrodes are not suited for mass production or use in a variety of ways.

The object of the present invention, therefore, is to provide a light source of the aforementioned type as well as a method which allow the light source to be used in a variety of ways, even under severe conditions of use.

The above-referenced object is achieved according to the invention by a light source having the features of Claim 1, and by a method having the features of Claim 18. Accordingly, the light source of the aforementioned type is designed and refined in such a way that the filament or electrode is provided with mechanical stabilization, at least in places.

According to the invention, it has been recognized from the outset that the present filament or electrode material may be influenced in a targeted manner to reduce the sensitivity of the known light source. It is therefore not necessary to use some other, less sensitive filament or electrode material. Specifically, to achieve the above-referenced object the filament or electrode is provided with mechanical stabilization, at least in places. In this manner mechanical stabilization may be produced, at least in places, at locations on the filament or electrode that have been shown to be particularly sensitive. The sensitivity of the light source to shocks and vibrations is thereby significantly reduced.

Consequently, the light source according to the invention provides a light source which can be used in a variety of ways, even under severe conditions of use having intense shocks and vibrations.

In practice, it has been shown that breakage of the filament or electrode occurs in particular in the region where the filament or electrode exits from a glass bulb, for example. Thus, the stabilization may be provided in a particularly advantageous manner in the region where the filament or electrode exits from the bulb or tube. Stabilization only in this particular region is usually sufficient.

Specifically, the stabilization may be provided in the region of an electrical lead to the filament or electrode. In this regard, consideration should be made for the fact that the part of a filament, for example, which glows during operation is frequently formed by a spiral-wound filament. In this case the stabilization may be present outside this spiral-wound filament region, namely, in the region of the electrical lead for the filament or electrode.

With regard to a particularly secure and resistant stabilization, the stabilization may be provided by a coating or deposition on the filament or electrode. Multiple techniques which as a whole ensure a high mechanical stabilization may be used for this purpose.

Firstly, the coating or deposition may be produced by electrolytic means. A drop of electrolyte may be applied to the region of the filament or electrode to be stabilized, the filament being used as a cathode. A thin metal wire, for example, may then be inserted as an anode for this electrolytic minisystem. Copper or nickel, for example, may be deposited as a localized plating at a suitable deposition voltage. In another design, however, iron, molybdenum, tungsten, or alloys thereof, or some other metal may be used for the coating or deposition. W/Ni alloys may also be deposited. After removal of the electrolyte and drying, the stability of the filament or electrode system against impact stress is noticeably higher following the electrolytic coating or deposition.

Chemical vapor deposition (CVD) may be used as an additional coating technique. For this purpose carbon, for example, may be applied to the filament or electrode. Since when the light source is lit, the region of the filament or electrode to be stabilized has a lower temperature than the glowing part which is usually located thereabove, when temperature distribution and gas feed are optimized a hydrocarbon compound may be decomposed in the hotter region and deposited as carbon in the cooler region facing away from a spiral-wound filament. Compared to conventional light sources, a light source having such a design is stable against impact stress to the filament or electrode, even at doubled g values or acceleration values.

In another technique, the coating or deposition may be produced by inorganic covalent or metal organic chemical vapor deposition (MOCVD). As an alternative to carbon deposition using CVD, a metal may also be deposited according to the same principle. As process gas which is subjected to thermal decomposition, either inorganic covalent compounds, such as metal chlorides or metal fluorides, or organometallic compounds such as titanium tetrachloride for a titanium deposition, metal hexacarbonyl for a chromium, molybdenum, or tungsten deposition, or ferrocene for an iron deposition may be used. Other metals or organometallic compounds thereof may also be used as coating or deposition materials.

In another particularly advantageous technique, the stabilization may be provided by exposing the filament or electrode to one or multiple short pulsed increases in gas pressure, using an inert gas, during heating.

Such a treatment of the filament or electrode with a short inert gas pulse may be carried out in particular during or immediately after synthesis or manufacture of the filament or electrode, in which the filament or electrode is already situated in the bulb or tube. In such a manufacturing or synthesis design it is particularly simple to adjust the gas atmosphere around the filament or electrode by selective gas feeding.

In the synthesis of a tantalum carbide filament, for example, tantalum is used as the starting material. This starting material is then subjected to carburization at 3000 to 3300 K. Starting with Ta, Ta₂C and then TaC are produced. CH₄ and a small quantity of H₂ at a gas pressure of approximately 0.1 to 10 mbar are used as gases in the gas atmosphere surrounding the starting material. The synthesis lasts approximately five to six minutes. The pressure during carbon deposition is approximately 10 to 50 mbar. The inert gas pulse treatment is carried out at approximately 3000 to 3150 K. The pressure during the inert gas treatment is preferably approximately 20 mbar.

After the filament or electrode is treated with a short inert gas pulse, a significant increase in the strength and stability of the filament or electrode, in particular in the region where the filament or electrode exits from the bulb or tube, is exhibited. More precisely, the customary strength values corresponding to a stability under a stress up to 100 g to 200 g may be increased to above 2000 g. In other words, the light source stabilized according to the invention remains unimpaired, even at an impact stress greater than 2000 g.

In practice, it has been shown to be beneficial to expose the filament or electrode to a constant inert gas pressure after one or multiple short pulsed increases in gas pressure, up to the end of the synthesis. The stability may be increased in this manner.

Specifically, the pulsed increase in gas pressure may last approximately 10 to 20 seconds, resulting in optimum stabilization of the filament or electrode.

A gas pressure of approximately 15 to 25 mbar is advantageously suitable for the increase in gas pressure. The gas pressure may preferably be approximately 20 mbar.

Helium and argon are particularly suitable inert gases for stabilization. However, other inert gases such as neon, krypton, or xenon may also be used.

In one specific design of the light source according to the invention, the filament or electrode may include tantalum carbide or may be composed of tantalum carbide.

With regard to the claimed method according to the invention, the above-referenced object is achieved by a method for mechanically stabilizing the filament or electrode of a light source, having the features of claim 18. The stabilization is provided by exposing the filament or electrode to one or multiple short pulsed increases in gas pressure, using an inert gas, during heating, or by means of a coating or deposition.

The stabilization may be provided during or after synthesis of the filament or electrode. The filament or electrode may advantageously be exposed to a constant inert gas flow or pressure after one or multiple short pulsed increases in gas pressure. The increase in gas pressure may last approximately 10 to 20 seconds. The increase in gas pressure may be achieved using a gas pressure of approximately 15 to 25 mbar, preferably approximately 20 mbar. Helium and argon may be used as inert gas, although other inert gases such as neon, krypton, or xenon may also be used.

The heating during the short pulsed increase in gas pressure may be achieved using a resistive heating process in which the current flows through the filament or electrode.

For stabilizing the light source, a short pulsed increase in gas pressure may be achieved in a particularly advantageous manner by exposing the filament or electrode during heating, and also by providing a coating or deposition on the filament or electrode. In this manner a combined effect may be achieved for stabilizing the light source.

The effect of the increase in stability as a result of treating the filament or electrode with a short pulsed increase in gas pressure could be explained by a reduction in hydrogen embrittlement in the supply leads of the filament or electrode due to dilution of the gas atmosphere. Alternatively, the effect could also be explained by a marginal surface decarburization in the supply leads, which for a tantalum carbide filament might result in a very thin outer tantalum covering having a mechanically stabilizing effect. A further explanation could be the pulsing of a very dynamic temperature gradient in the supply leads of the filament or electrode, which could result in a shift in the target breakage site in the glass body or glass socket of a bulb or tube.

In addition to mechanical stabilization, metal depositions may also be used for introducing catalytically active metals into the bulbs or tubes of the light source. This allows the gas phase chemistry in the glowing light source to be influenced in a desired direction in a targeted manner.

The aim of the invention is to reduce the brittleness of filaments or electrodes, in particular for bulbs using carbide such as TaC for this purpose. Filaments and electrodes are also collectively referred to as lighting means for an incandescent or discharge lamp. As a result of the invention, mechanical stabilization is provided not only for the cold lighting means during transport to the customer, but also for the lighting means, in particular a filament which has been brought to operating temperature, in the region of the pinch edge or filament-frame connection. It is advantageous to integrally join the lighting element to an internal power lead which extends into the glass of the bulb. The exit points for the lighting means, for example the TaC filament, in the region of the pinch edge or the filament suspension usually comprise the brittle Ta₂C phase or the pure Ta phase which has not yet carburized. As a result of the invention, adhesion of the Ta material to the quartz glass (such as during pinching, for example) is prevented, in particular at the pinch edge. The Ta filament undergoes a volume increase of 21% as the result of phase transformation to TaC. When the connection to the quartz glass is too tight, this may result in breakage, or at least an increase in resistance at the pinch edge. A further advantage during operation of the bulb is the reinforcement of the cold exit points, at which location halogen corrosion or other chemical reactions of other embrittling filler gas components (hydrogen, nitrogen, oxygen, etc.) occur. In this manner it is possible to stabilize in particular the filament, i.e., the spiral-wound filament, for bulbs without a frame, i.e., bulbs in which the spiral-wound filament and the internal power lead are integrated, whereby the wire forming the spiral-wound filament is welded directly to the film, and the stabilization aid has a mechanical stabilizing effect and with regard to the electrical characteristic values, in particular regarding any changes in resistance, in both the cold state and during the glowing process. The stabilization is a coating or a spiral-wound filament, but preferably is a suitable combination of both. A spiral-wound filament or tube is applied as a sleeve directly onto the wire, and the coating is then additionally applied.

The spiral-wound filament sleeve or tube sleeve is preferably made of high-melting metal. The melting point of the metal should be at least 1900° C., and the preferred material is W, Mo, carbon, Ta, Ru, Hf, or Os. The maximum length of the sleeve should correspond to the length of the internal power leads inside the bulb. A typical length is 5% of the length of the internal power leads, preferably a value from 3 to 15% of this length.

This “rough mechanical” sleeve should be combined with one of the above-referenced “precisely acting” stabilizing means, namely: (a) carbon deposition, in particular at the transition from the spiral-wound filament sleeve to the simple TaC wire, (b) metal deposition, or (c) inert gas stabilization, principally by use of helium.

The particular referenced option ultimately used in combination with the sleeve, and the material from which the sleeve is produced, depend on the filling gas system that is selected. The chemical components of the filling gas system, the material, and the maximum temperature of the spiral-wound filament sleeve and the additional stabilization selected from options (a) through (c), as well as the design thereof, in particular regarding the material selection for (b), should be as compatible as possible.

This technique is also suited for use in bulbs having separate frame parts. In this context, “electrode” is understood to mean a particularly solid internal power lead which clamps the spiral-filament lighting element, the filament. In this instance, the critical breakage region is the transition from the TaC filament to the spiral-wound filament clamp/weld on the electrode.

Various possibilities exist for advantageously designing and refining the teaching of the present invention. In this regard reference is made to the claims subordinate to claims 1 and 18, and to the following discussion of preferred exemplary embodiments of the invention according to the drawing. In conjunction with the discussion of the preferred exemplary embodiment of the invention according to the drawing, preferred designs and refinements of the teaching are also explained in general. The drawing shows the following:

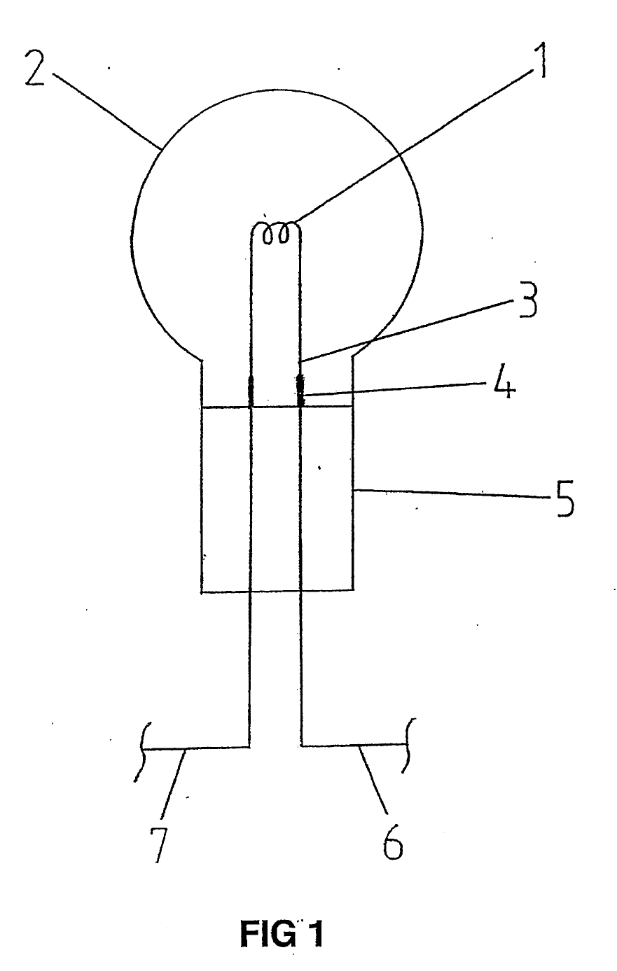

FIG. 1 shows one exemplary embodiment of a light source according to the invention, in a schematic side view; and

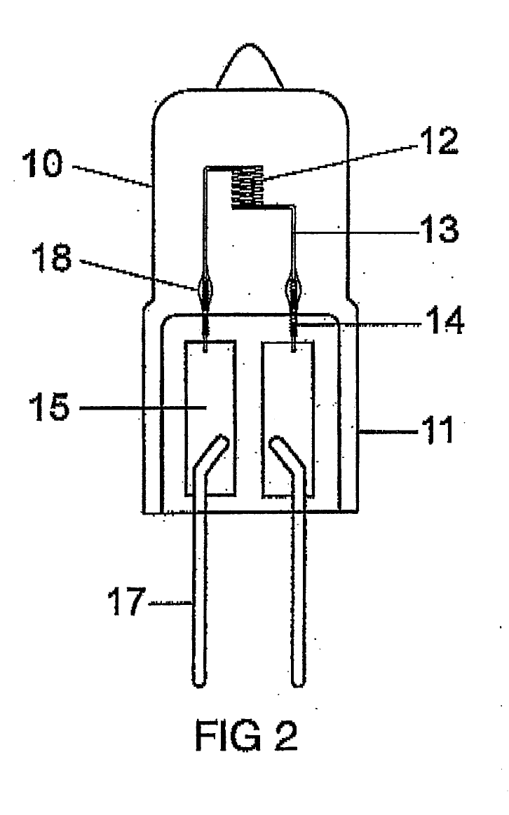

FIGS. 2 through 7 each show schematic views of further exemplary embodiments of a light source according to the invention.

FIG. 1 shows one exemplary embodiment of a light source according to the invention, in a schematic side view. The light source has a heatable filament 1 situated in a bulb 2. In order to use the light source in a variety of ways, even under severe and high-vibration conditions, the filament 1 is provided with mechanical stabilization in places. The stabilization is provided in the region of an electrical lead 3 for the filament 1 as the result of an electrolytic deposition 4.

However, a coating could also be provided by chemical vapor deposition (CVD) for stabilization of the filament 1. The deposition 4 is provided in the region where the filament 1 exits from a glass socket 5 for the bulb 2. This region of the filament 1 is most sensitive to breakage of the filament 1 during handling of the light source.

In the current exemplary embodiment the filament 1 is made of tantalum carbide. The electrical contacting for the filament 1 is established via electrical contacts 6 and 7.

Alternatively or additionally, the filament 1 may be stabilized by exposing the filament 1 to a short pulsed increase in gas pressure, using an inert gas, during heating. This also results in much greater mechanical stability of the filament 1, particularly in the region where the filament 1 exits from the glass socket 5.

Helium or argon may preferably be used in this instance as inert gas.

FIG. 2 shows a halogen lamp comprising a bulb 10 and a pinch 11. A spiral-wound filament 12 as lighting element is axially situated in the bulb. The spiral-wound filament has internal power leads 13 which are integrally mounted to the ends of the spiral-wound filament. The material is TaC. A spiral-wound filament sleeve or spiral 14 extends as a rough mechanical covering means over a length of approximately 5% of the length of the power lead 13 in the bulb, and extends into the pinch and stabilizes the power lead. The outer end of the internal power lead is connected to a film 15 in the pinch 11 of the bulb. Solid outer power leads 17 project outwardly from the pinch 11. A coating 18 of carbon or also of metal is applied by means of CVD in the region of the inner end of the spiral-wound filament sleeve for further stabilization, somewhat in the manner of a precision mechanical support. This coating is typically up to 30 μm thick at the center, and extends at least over a length of 2 mm on the region of the internal power lead which is not supported by the spiral-wound filament sleeve. The coating also extends over a portion of the spiral-wound filament sleeve itself. In this manner optimal protection is provided against breakage in the region of the edge between the end of the spiral-wound filament sleeve and the internal exposed power lead. A region of at least 2 mm on the spiral-wound filament sleeve is preferably coated. In this manner not only the supporting effect but also the electrical contact is improved.

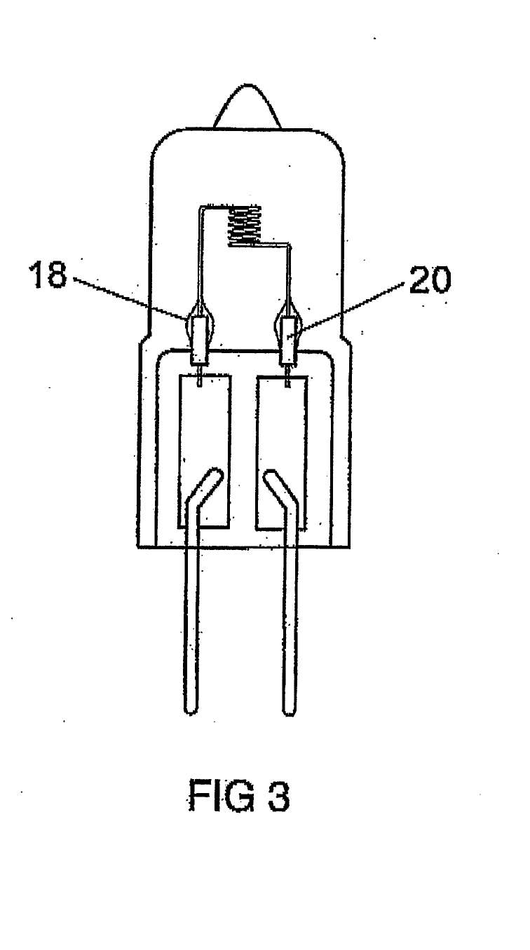

A further exemplary embodiment is shown in FIG. 3, corresponding essentially to the exemplary embodiment of FIG. 2, except that the sleeve is formed by a tube 20 extending into the bulb over a length of approximately 10% of the length of the internal [power lead]. Otherwise the design is similar to that of FIG. 2.

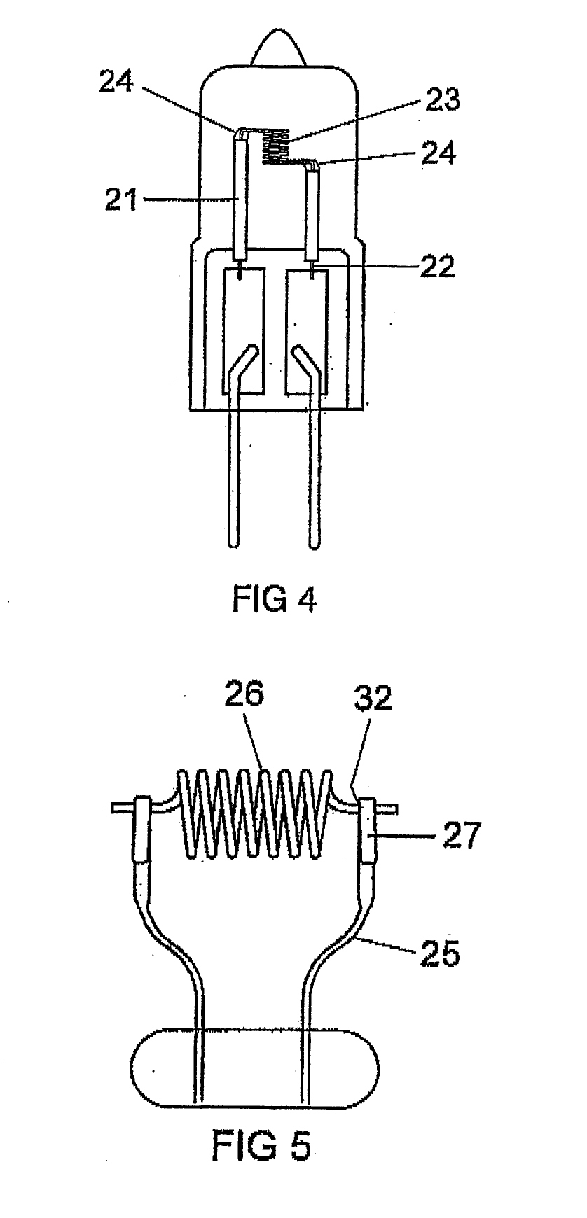

FIG. 4 shows an exemplary embodiment in which the supporting sleeve 21 extends relatively broadly over almost the entire length of the integral internal power lead 22. The coating 24 extends from the end of the tube toward the lighting element 23.

The length of the sleeve in the pinch is typically approximately 0.5 to 3 mm, preferably 0.5 to 1.5 mm. The length of the internal power lead on the film is advantageously 1 to 3 mm.

FIG. 5 shows a section of a halogen lamp having separate, in particular solid, frame wires made of molybdenum as internal power leads 25. Such lamps are used in particular for photo-optical purposes. The lighting element 26 made of HfC is clamped between the bent leg 27 of the two frame wires. In this case, a support spiral-wound filament as supporting sleeve is not necessary. The coating is made of carbon or metal, and extends to the exit points for the spiral-wound filament, i.e., the nonspiral ends of the spiral-wound filament, in particular to a zone in the vicinity of the contact for the frame. The stabilization may also be provided by inert gas. In this case no coating is necessary, as shown.

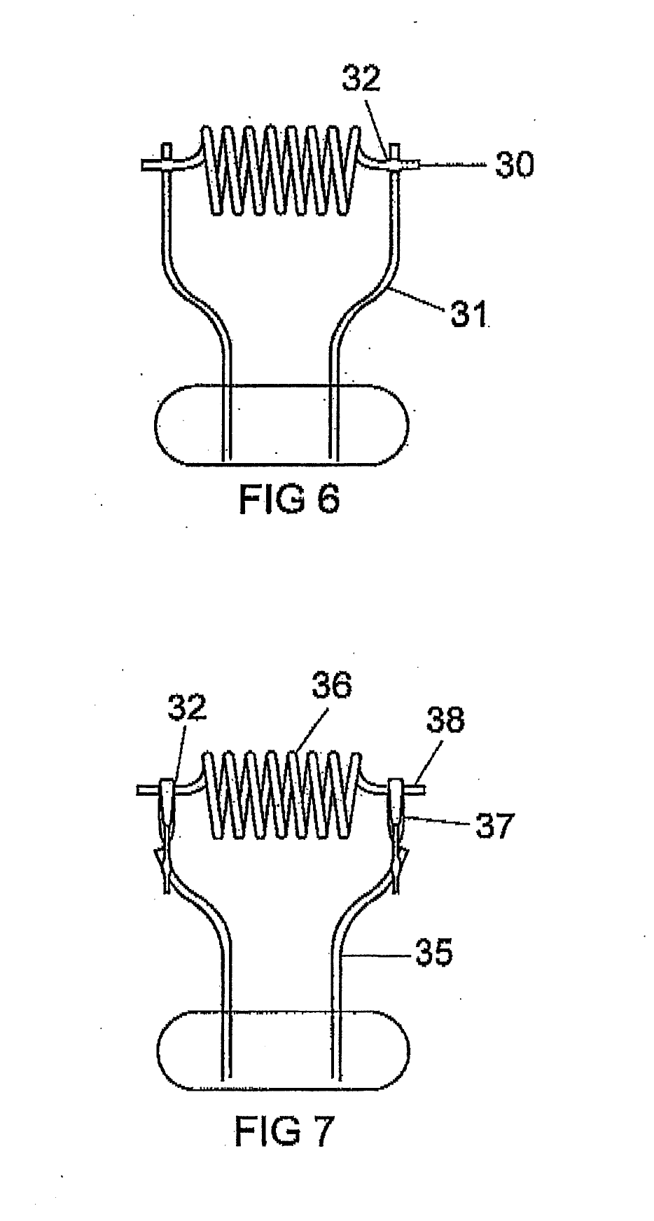

FIG. 6 shows a similar design in which the exit points 30 for the spiral-wound filament are welded to the solid frame wires 31. Here as well, the coating is approximately 2 mm in both directions, viewed from the contact point 32. The stabilization may also be provided by inert gas. In this case no coating is necessary, as shown.

Furthermore FIG. 7 shows an exemplary embodiment in which the frame wire is produced from two separate solid parts. The outer part 35 extending into the pinch is made of molybdenum, and has an outward right-angle bend. The inner part 37 extending to the TaC spiral-wound filament 36 is made of some other material, advantageously Ta or Nb. This inner part is once again the actual holder for the exit points 38 for the spiral-wound filament. The exit point for the spiral-wound filament is held once again by means of a clamp, as illustrated, or also by welding. Here as well, an end-position part of the spiral-wound filament is coated with metal, for example rhenium, osmium, iridium, or ruthenium, over a length of at least 1 mm, starting from the contact point 32 in the direction of the spiral-wound filament. The coating may also extend in the direction of the frame, in a width of preferably 1 to 3 mm. The stabilization may also be provided by inert gas. In this case no coating is necessary, as shown.

In glowing bulbs having a lighting element made of metal carbide, filling gas mixtures are generally used which enable a carbon circulation process. One possibility, for example, is the addition of carbon and hydrogen for the filling gas (see, for example, U.S. Pat. No. 2,596,469). In this case it is practical to select the material of the spiral-wound filament sleeve and, if applicable, of a metallic coating, such that said materials have little or no reaction with carbon to form carbides, or have little or no dissolving effect for carbon or hydrogen. In these cases rhenium, osmium, iridium, or ruthenium are considered to be particularly suitable materials. These materials withdraw much less carbon from the gas phase than do tungsten or molybdenum, for example, or dissolve less hydrogen than do tantalum and zirconium, for example (which in fact have been frequently referenced in the literature as hydrogen getters).

If the spiral-wound filament sleeve projects only a few mm from the pinch, as described for one preferred embodiment, and if a carbon circulation process is implemented in the bulb, the spiral-wound filament sleeve may preferably also be produced from tungsten or molybdenum, since at the low temperatures in the vicinity of the pinch edge carbon is dissolved only very slowly in the metal, and the referenced materials in the gas phase withdraw a comparatively small amount of hydrogen.

If the exit point up to the higher-temperature region is covered with a metal to stabilize the breakage-sensitive regions in which the Ta₂C phase dominates, the metals rhenium, osmium, iridium, or ruthenium are particularly suited for this purpose, since during lamp operation very little carbon is withdrawn from the gas phase when these metals are used. A further advantage of using these metals is that they greatly retard the uptake of hydrogen by the noncarburized tantalum in the vicinity of the pinch edge. The partial pressure of hydrogen in the bulbs is thus more stable than for a continuous strong hydrogen getting process in the vicinity of the pinch edge.

In one preferred design when a C—H circulation process is used, the exit points of the spiral-wound filament are therefore covered with one of the metals rhenium, osmium, iridium, or ruthenium up to the vicinity of the lighting element, whereas the spiral-wound filament sleeve produced from molybdenum or tungsten projects only a few mm from the pinch edge. Instead of the metal deposition, C deposition may also be used which extends up to the vicinity of the lighting element.

The application for WO 2004/107391 A1 describes that the use of oxygen-containing additives for the filling gas can achieve a positive effect for avoiding bulb darkening, i.e., increasing the service life. The beneficial effect of the oxygen may be increased even more by using metals such as iron, cobalt, nickel, or molybdenum in the cooler regions at temperatures generally around 150° C. to 400° C. These metals likely act as catalysts in the sense of Fischer-Tropsch reactions, in which the carbon monoxide on the catalyst reacts with hydrogen to form hydrocarbons and water. In this manner the otherwise very stable carbon monoxide molecule is decomposed, and both carbon and oxygen are recycled to the reaction. The hydrocarbon decomposes on its path to the lighting element with the release of carbon, which may re-attach to the lighting element. The released oxygen reacts with the carbon transported by the lighting element to form carbon monoxide. Since in contrast to the reaction of the carbon with the hydrogen this reaction proceeds at much higher temperatures, darkening of the bulb is prevented much more effectively. The metals in question are most effective with regard to catalysis of the referenced reaction when they are used at temperatures around or below 500° C., in particular 400 to 550° C. The metals considered for the referenced catalysis tend to form carbides or to dissolve carbon at higher temperatures. In preferred designs, therefore, the spiral-wound filament sleeve is made from these materials and designed so as to project only a few millimeters beyond the pinch edge. In one preferred design using the C—O—H filling gas system, use of the described spiral-wound filament sleeve is combined with carbon deposition at higher temperature, or with inert gas stabilization.

In a further design, the spiral-wound filament is attached to solid stable power leads (“frame”), as shown in FIGS. 5 through 7. The spiral-wound filament is attached by clamping or welding, for example. The very stable power leads (i.e., frame parts) usually have a sufficiently large diameter, and thus adequate heat conductivity or low resistance, such that they are present at a low temperature at which significant carburization does not occur. A material is preferably selected for the frame which does not significantly dissolve hydrogen, such as W or Mo. An additional advantage of using these materials is that these metals act as catalysts when the C—H—O filling gas system is used (see above). In addition, when this design is used the tantalum spiral-wound filament does not completely carburize; the cooler regions are not completely carburized near the location where the exit points for the spiral-wound filament are fixed to the frame parts. To increase the breakage resistance in this region, the zone in which the brittle Ta₂C phase dominates is again coated with a stabilizing metal layer, preferably using a metal that does not tend to carburize (Os, Ru, Re, Ir, for example). Instead of a metal deposition, the region in question may also be stabilized by a carbon coating, or inert gas stabilization may be used.

In one preferred design when the C—H—O filling gas system is used, materials having a catalytic function, for example molybdenum, are used for the power leads. The exit points for the TaC lighting element are coated with a carbon deposition.

With regard to further advantageous embodiments and refinements of the teaching of the invention, to avoid repetition reference is made to the general portion of the description and the accompanying claims.

Lastly, it is emphasized in particular that the above exemplary embodiment, selected purely arbitrarily, is used solely to illustrate the teaching of the invention, but does not limit said teaching to this specific exemplary embodiment.

1. Light source having a heatable filament (1) or electrode, the filament (1) or electrode being situated in a bulb (2) or tube, characterized in that the filament (1) or electrode has mechanical stabilization, at least in places.

2. Light source according to claim 1, characterized in that the stabilization is provided in the region where the filament (1) or electrode exits from the bulb (2) or tube.

3. Light source according to claim 1, characterized in that the stabilization is provided in the region of an electrical lead (3) for the filament (1) or electrode.

4. Light source according to claim 1, characterized in that the stabilization is provided by a coating or deposition (4).

5. Light source according to claim 4, characterized in that the coating or deposition (4) is produced by electrolytic means.

6. Light source according to claim 4, characterized in that the coating or deposition (4) includes a metal, preferably copper, iron, nickel, molybdenum, tungsten, or alloys thereof.

7. Light source according to claim 4, characterized in that the coating or deposition is produced by chemical vapor deposition (CVD).

8. Light source according to claim 4, characterized in that the coating or deposition includes carbon.

9. Light source according to claim 4, characterized in that the coating or deposition is produced by inorganic covalent or metal organic chemical vapor deposition (MOCVD).

10. Light source according to claim 7, characterized in that the coating or deposition includes a metal selected from the group consisting of titanium, chromium, molybdenum, tungsten, iron, and the organometallic compounds thereof.

11. Light source according to claim 1, characterized in that the stabilization is provided by exposing the filament (1) or electrode to one or multiple short pulsed increases in gas pressure, using an inert gas, during heating.

12. Light source according to claim 11, characterized in that the stabilization is provided during or immediately after synthesis of the filament (1) or electrode.

13. Light source according to claim 11, characterized in that the filament (1) or electrode is exposed to a constant inert gas flow or pressure after one or multiple short pulsed increases in gas pressure.

14. Light source according to claim 11, characterized in that the increase in gas pressure lasts approximately 10 to 20 s.

15. Light source according to claim 11, characterized in that the increase in gas pressure is achieved using a gas pressure of approximately 15 to 25 mbar.

16. Light source according to claim 11, characterized in that the inert gas is selected from the group consisting of helium, argon, neon, krypton, and xenon.

17. Light source according to claim 1, characterized in that the filament (1) or electrode includes tantalum carbide.

18. Method for mechanically stabilizing the filament (1) or electrode of a light source according to claim 1, the stabilization being provided by exposing the filament (1) or electrode to one or multiple short pulsed increases in gas pressure, using an inert gas, during heating, or by means of a coating or deposition (4).

19. Method according to claim 18, characterized in that the stabilization is provided during or after synthesis of the filament (1) or electrode.

20. Method according to claim 18, characterized in that the filament (1) or electrode is exposed to a constant inert gas flow or pressure after one or multiple short pulsed increases in gas pressure.

21. Method according to claim 18, characterized in that the increase in gas pressure lasts approximately 10 to 20 s.

22. Method according to claim 18, characterized in that the increase in gas pressure is achieved using a gas pressure of approximately 15 to 25 mbar.

23. Method according to claim 18, characterized in that the inert gas is selected from the group consisting of helium, argon, neon, krypton, and xenon.

24. Light source according to claim 1, characterized in that the mechanical stabilization is achieved by a combination of a rough mechanical coating means and a precisely acting supporting means.

25. Light source according to claim 24, characterized in that the rough mechanical coating means is a spiral-wound filament sleeve, spiral, or tube, and the precisely acting supporting means is a coating made of carbon or metal, or is a stabilizing inert gas treatment.

26. Light source according to claim 24, characterized in that the rough mechanical coating means supports the region of the internal power lead which seals the corner.

27. Light source according to claim 24, characterized in that the precisely acting supporting means supports at least the region of the internal power lead which directly adjoins the rough mechanical coating means in the direction of the lighting element.

28. Light source according to claim 27, characterized in that the precisely acting supporting means also extends over a region of the rough mechanical coating means.
